(19) United States
(12) Patent Application Publication
(10) Pub. No.: US 2026/0065128 A1
(43) Pub. Date: Mar. 5, 2026

(54) PRESERVING DECISION VALUE ORDER WHILE TRAINING SUCCESSIVE ARTIFICIAL INTELLIGENCE MODEL RELEASES

(71) Applicant: CrowdStrike, Inc., Sunnyvale, CA (US)

(72) Inventors: Michael Slawinski, Rancho Santa Margarita, CA (US); Patrick Crenshaw, Atlanta, GA (US)

(21) Appl. No.: 18/818,209

(22) Filed: Aug. 28, 2024

(51) Int. Cl. G06N 20/00

(52) U.S. Cl. CPC G06N 20/00

(57) ABSTRACT

The present disclosure provides an approach of producing, by a first artificial intelligence (AI) model, decision values corresponding to data samples in a validation dataset. The processing device determines a decision value order of the data samples based on the decision values. In turn, the processing device trains a second AI model based on the decision value order and the data samples to generate an output from an input dataset.

### TECHNICAL FIELD

Aspects of the present disclosure relate to training artificial intelligence (AI) models, and more particularly, to preserving decision value order while training successive AI model releases.

### BACKGROUND

Artificial intelligence (AI) is a field of computer science that encompasses the development of systems capable of performing tasks that typically require human intelligence. Machine learning is a branch of artificial intelligence focused on developing algorithms and models that allow computers to learn from data and make predictions or decisions without being explicitly programmed. Machine learning models are the foundational building blocks of machine learning, representing the mathematical and computational frameworks used to extract patterns and insights from data. Large language models, a specialized category within machine learning models, are trained on vast amounts of text data to capture the nuances of language and context. By combining advanced machine learning techniques with enormous datasets, large language models harness data-driven approaches to achieve highly sophisticated language understanding and generation capabilities. As discussed herein, artificial intelligence models, or AI models, include machine learning models, large language models, and other types of models that are based on neural networks, genetic algorithms, expert systems, Bayesian networks, reinforcement learning, decision trees, or combination thereof.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for preserving decision value order in successive AI model releases, in accordance with some embodiments of the present disclosure.

FIG. 2A is a diagram that illustrates an example of a decision value order from a first AI model, in accordance with some embodiments of the present disclosure.

FIG. 2B is a diagram that illustrates an example of a decision value order from a first training iteration of a second AI model, in accordance with some embodiments of the present disclosure.

FIG. 2C is a diagram that illustrates an example of order offsets to feed into a model trainer based on a first iteration decision value order, in accordance with some embodiments of the present disclosure.

FIG. 2D is a diagram that illustrates an example of a decision value order from a second training iteration of a second AI model, in accordance with some embodiments of the present disclosure.

FIG. 3 is a flow diagram of a method 300 for preserving decision value order in successive AI model releases, in accordance with some embodiments of the present disclosure.

FIG. 4 is another flow diagram of a method 400 for integrating a warm start approach to preserve decision value order in successive AI model releases, in accordance with some embodiments of the present disclosure.

FIG. 5 is a block diagram that illustrates an example system for preserving decision value order in successive AI model releases, in accordance with some embodiments of the present disclosure.

FIG. 6 is a block diagram of an example computing device that may perform one or more of the operations described herein, in accordance with some embodiments of the present disclosure.

### DETAILED DESCRIPTION

Artificial Intelligence (AI) models are trained through a systematic process that involves the use of large amounts of data and sophisticated algorithms. The training process begins with a selection of a dataset that is representative of the problem domain the model aims to address. The dataset is then divided into a training dataset and a validation dataset. The training dataset is used to teach the AI model by feeding it data and adjusting its internal parameters based on the errors the AI model makes in its predictions. The validation dataset is used by the AI model to tune hyperparameters and assess performance during the training process, ensuring that the AI model generalizes well to unseen data and prevent overfitting. Overfitting occurs when an AI model learns the training dataset too well, including its noise and outliers, resulting in poor generalization to new, unseen data.

While testing the validation dataset, AI models output a decision value within a fixed range of values. A decision value is a numerical value that represents the AI model's confidence or probability estimate for a given prediction. In binary classifiers, model developers set a threshold to transform the decision value into a binary decision (e.g., negative or positive). An effective approach for setting the threshold is by tying the threshold to a target false positive rate. A target false positive rate is a predefined percentage of negative instances during validation dataset testing that are incorrectly classified as positive by a model, which is determined based on balancing trade-offs between false positives and false negatives. A false positive is an error where an AI model incorrectly predicts a negative instance as positive, while a false negative is an error where an AI model incorrectly predicts a positive instance as negative. For example, in a binary classifier, a higher threshold may reduce false positives but increase false negatives, whereas a lower threshold may have the opposite effect. The optimal threshold is chosen based on the requirements of the application and the acceptable trade-offs between false positives and false negatives.

The threshold is determined based on the target false positive rate of the validation data samples. The decision value order is the resulting order of the validation data samples based on their corresponding decision values. For example, using ten validation dataset samples and a 10% target false positive rate, if the validation data samples and corresponding decision values are [(s1, 0.1), (s2, 0.2), (s3, 0.3), (s4, 0.4), (s5, 0.5), (s6, 0.6), (s7, 0.7), (s8, 0.8), (s9, 0.9), (s10, 0.95)], then the threshold is set between 0.9 and 0.95. In addition, the threshold determines which one of the validation dataset samples will be a false positive, which is sample s10 in the above example.

At times, new releases of an AI model (second AI model) are produced to incorporate improvements that enhance the model's accuracy, efficiency, and adaptability to new data or changing conditions. These improvements can stem from several factors, including the availability of new training data, advancements in algorithms, or the need to address shortcomings observed in previous versions. During the development of a new release, the AI model is refined by optimizing its parameters, incorporating new features, and employing more sophisticated techniques to better capture underlying patterns. This iterative process ensures that each subsequent version of the model delivers better performance, reliability, and user satisfaction. However, due to different initial conditions such as new data and varying hyperparameters in AI model training between releases, successive AI models can produce different decision values for the same validation data samples. For example, an original AI model may produce decision value of 0.8 for data sample s8, but a second AI model release may produce a decision value of 0.85 for the same validation data sample s8.

Differences in decision values between AI model releases are not problematic if the decision value order remains consistent, such as when decision values for each data sample increases by 0.3. A challenge found, however, is that successive AI model releases do not typically preserve the decision value order, which leads to a phenomenon known as “decision value shuffling” where the order of the sample data changes based on their corresponding decision values. Decision value shuffling typically occurs because each AI model, even when trained on the same dataset, can develop slightly different internal representations and decision rules. The second AI model might weigh features differently or capture new patterns that the previous model did not, leading to variations in the decision values. Consequently, files or instances that were previously classified as negative by the original AI model might now be classified as positive by the second AI model, causing unexpected false positives, also referred to as surprise false positives. For example, for samples s1-s10, the original AI model may produce decision values that order the samples as (s1, s2, s3, s4, s5, s6, s7, s8, s9, s10), whereas the second AI model may produce decision values that order the samples as (s1, s2, s3, s4, s5, s6, s7, s8, s10, s9). As such, s10 is a false positive to the original AI model, but s9 is a “surprise”false positive to the second AI model.

The present disclosure addresses the above-noted and other deficiencies by using a processing device to produce, using a first AI model, decision values corresponding to data samples from a validation dataset. The processing device determines a decision value order of the data samples based on their corresponding decision values. In turn, the processing device trains a second AI model based on the decision value order and the data samples to generate an output from an input dataset. In some embodiments, the decision values include prediction values corresponding to the data samples, and the decision value order represents an order of the data samples based on their respective prediction values. In some embodiments, using the decision value order to train the second AI model preserves the order of the data samples between the first AI model and the second AI model. In some embodiments, preserving the order of the data samples reduces a number of surprise false positives from the second AI model.

In some embodiments, the processing device initializes the second AI model with a set of parameters and uses the second AI model to compute prediction values for the data samples. The processing device then determines a new decision value order of the validation dataset based on the prediction values. Then, the processing device determines gradient offsets based on a difference between the decision value order and the new decision value order. In turn, the processing device updates the set of parameters of the second AI model based on the gradient offsets.

In some embodiments, the first AI model includes a decision tree ensemble of decision trees. The processing device parses at least one decision tree from the decision trees to produce a parsed decision tree ensemble. The processing device trains a new decision tree based on the decision value order from the first AI model, and appends the new decision tree to the parsed decision tree ensemble to produce the second AI model. In some embodiments, training the new decision tree is based on a differential training dataset corresponding to a difference between a training dataset used to train the first AI model and an updated training dataset.

As discussed herein, preserving the decision value order of an AI model when updating to a second AI model enhances the operation of a computer system and advances the technological field of AI model training. By preserving the decision value order, the system ensures that similar data points receive stable and predictable classifications across different model versions. This stability reduces the incidence of surprise false positives, thereby increasing the reliability and accuracy of the AI model's predictions. Consequently, end-users experience fewer disruptive reclassifications and erroneous alerts, leading to improved user trust and satisfaction. From a technological perspective, this approach promotes more refined successive AI model releases and facilitates smoother transitions between AI model versions, therefore reducing the need for extensive retraining or recalibration. Overall, preserving decision value order streamlines system operations, enhances user experience, and fosters the development of more robust and reliable AI models.

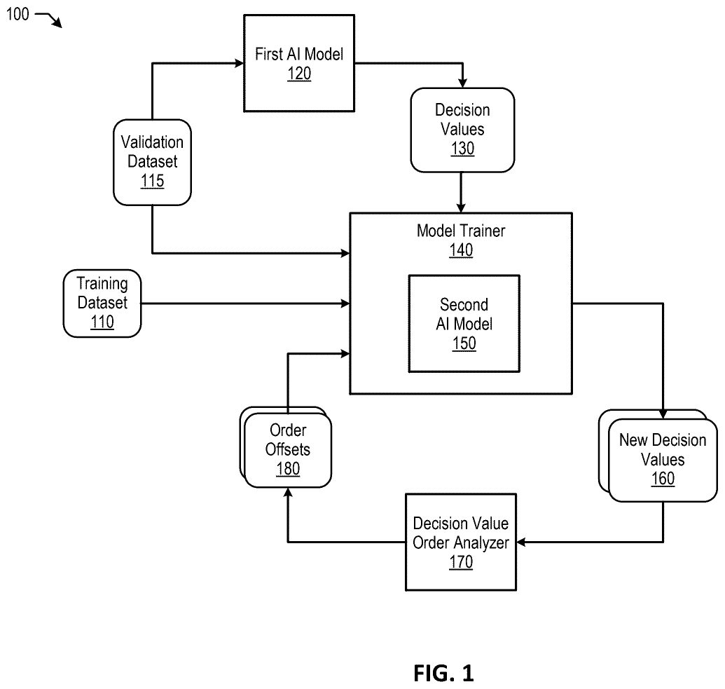

FIG. 1 is a block diagram that illustrates an example system for preserving decision value order in successive AI model releases, in accordance with some embodiments of the present disclosure.

System 100 includes model trainer 140. In one embodiment, model trainer 140 uses gradient boosting to train AI models. Gradient boosting, such as XGBoost (eXtreme Gradient Boosting), is a machine learning technique used to train AI models, particularly to train AI models targeted for regression and classification. Gradient boosting builds a model in a stage-wise manner by combining predictions of several base models (e.g., decision trees). The training process starts with an initial model, often a simple model that makes constant predictions. In each subsequent iteration, a new weak learner is trained to predict the residual errors, the differences between the actual target values and the predictions made by the current ensemble of models. A weak learner is a simple model that performs slightly better than random guessing and is used as a building block to incrementally improve overall predictive accuracy. These residuals are used to guide the training of the new learner. A new learner is an additional model trained in the iterative process of ensemble methods to correct the errors of the existing ensemble and enhance overall predictive performance. The predictions of the new learner are then combined with the predictions of the existing ensemble, often with a specific weight, to form an updated model. This process of training weak learners and combining their predictions continues iteratively until the model performance reaches a desired level of accuracy or a predetermined number of iterations is completed.

System 100 uses model trainer 140 to train second AI model 150 (e.g., AI model N+1), which is a successive release of AI model 120 (e.g., AI model N). System 100 inputs validation dataset 115 into AI model 120, and AI model 120 produces decision values 130 corresponding to data samples in validation dataset 115. For example, decision values 130 may include data sample ID's and their corresponding decision values (e.g., prediction values), such as [(s1,0.1), (s2, 0.2), (s3, 0.3), (s4, 0.4), (s5, 0.5), (s6, 0.6), (s7, 0.7), (s8, 0.8), (s98, 0.9), (s10, 0.95)]. In some embodiments, decision values 130 are indexed by sha256 strings created by hashing the data samples in validation dataset 115. In one embodiment, AI model 120 generates decision values 130 in real-time. In another embodiment, decision values 130 may be previously generated by AI model 120 and retrieved from memory. In one embodiment, validation dataset 115 feeds into a feature extraction engine to produce feature vectors, which are then fed into AI model 120 for evaluation.

Model trainer 140 receives training dataset 110, which may be the same training dataset or an updated version of the training dataset used to train AI model 120. In one embodiment, training dataset 110 is input into a feature extraction engine to produce feature vectors, which are then fed into model trainer 140 for training. Model trainer 140 may employ a training routine that involves iteratively training an ensemble of decision trees as discussed above. In one embodiment, model trainer 140 generates an ensemble of trees such that, for each iteration, the goal of model trainer 140 is to find an ensemble of trees that minimizes an objective function. An objective function is a mathematical formula that quantifies the error or loss of an AI model's predictions compared to actual values. The objective function it is used to guide the optimization process by adjusting the AI model's parameters to minimize this error.

During the training process, model trainer 140 generates gradient values and Hessian values to optimize second AI model 150's parameters. The gradient values represent the first-order derivatives of the loss function with respect to second AI model 150's predictions, indicating the direction and rate of change needed to minimize the error. The Hessian values, on the other hand, are the second-order derivatives of the loss function, providing information about the curvature of the error surface. These values are used to refine the optimization process by adjusting second AI model 150's parameters more accurately, allowing for faster convergence and improved model performance. Together, the gradient values and Hessian values help model trainer 140 efficiently build and update its ensemble of decision trees. As such, offsets may be added to the gradient values, Hessian values, or a combination thereof to guide model trainer 140 in adjusting some decision values of particular data samples to preserve the decision value order of AI model 120.

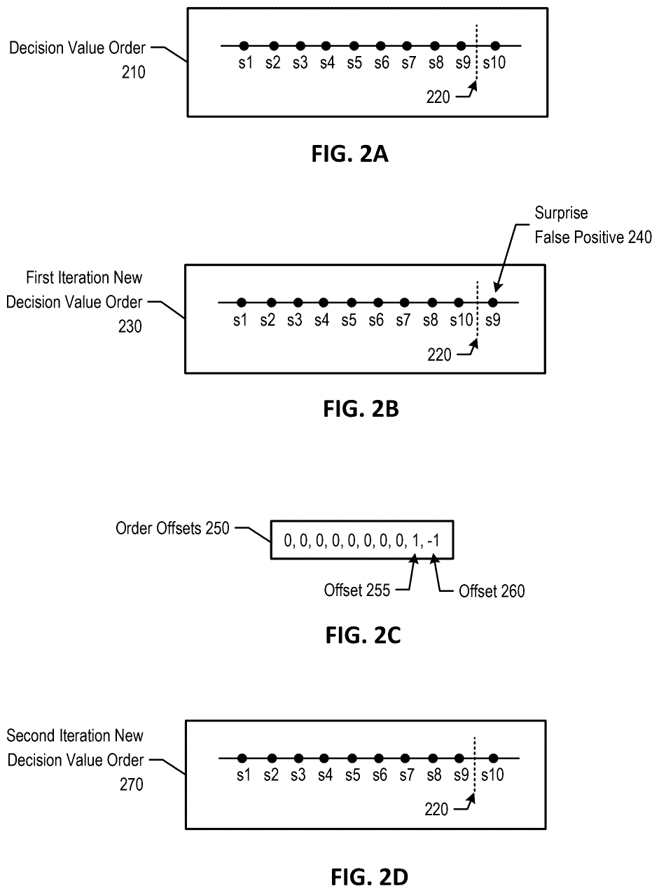

Model trainer 140 performs a first training iteration on the data samples in validation dataset 115 and produces a first iteration of new decision values 160. Decision value order analyzer 170 compares the decision value order of new decision values 160 with the decision value order of decision values 130 to determine whether the decision value order of second AI model 150 requires adjustment as discussed above. If the decision value order of second AI model 150 requires adjustment, decision value order analyzer 170 computes order offsets 180 to feed into model trainer 140. Order offsets may include gradient offsets, Hessian offsets, or a combination thereof. For example, if the decision value order of decision values 130 is (s1, s2, s3, s4, s5, s6, s7, s8, s9, s10), and the decision value order of new decision values 160 is (s1, s2, s3, s4, s5, s6, s7, s8, s9, s10), then decision value order analyzer 170 determines that order offsets 180 include gradient value offsets of (0, 0, 0, 0, 0, 0, 0, 0, +1, −1) to increase the decision value of s10 while decreasing the decision value of s9 (see FIGS. 2A-2D and corresponding text for further details).

Decision value order analyzer 170 sends order offsets 180 to model trainer 140, and model trainer 140 performs a second iteration of training to produce a second iteration of new decision values 160. Decision value order analyzer 170 evaluates the second iteration of new decision values 160 and generates a second round order offsets 180 if required. Model trainer 140 and decision value order analyzer 170 iteratively perform the operations discussed above until the decision value order of the second AI model 150 matches the decision value order of AI model 120. In turn, model trainer 140 and decision value order analyzer 170 ensure that second AI model 150 preserves the decision value order of AI model 120 and minimizes surprise false positives.

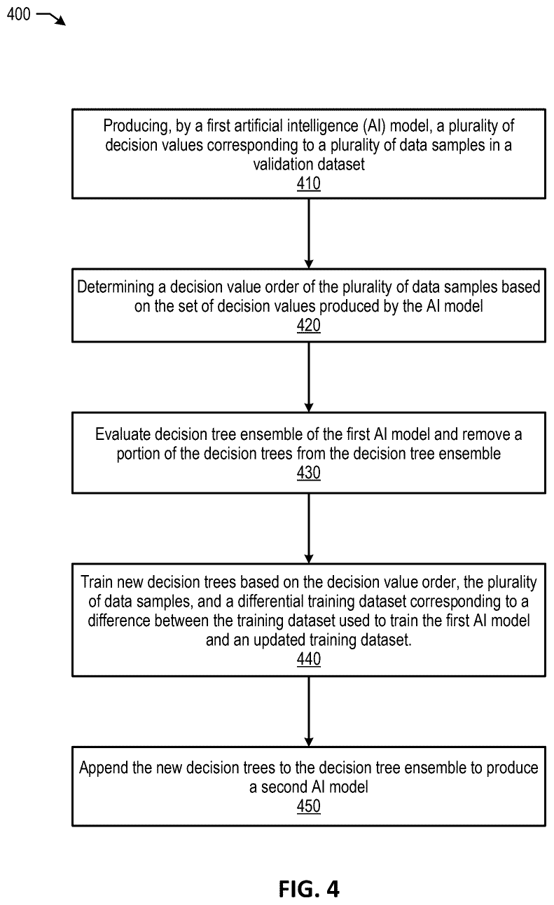

In one embodiment, rather than constructing a new ensemble of decision trees for second AI model 150 using a full training dataset 110, system 100 may integrate warm start training into the training process. Warm start training is a technique in machine learning that can be applied to decision tree ensembles, such as those used in gradient boosting algorithms. In this context, the training process begins by parsing and retaining some of the decision trees from the existing ensemble using, for example, hyperparameter tuning. Hyperparameter tuning includes selecting how many trees to retrain to balance model performance with computational efficiency. For each hyperparameter combination, a model is trained and the best model (e.g., based on as validation results) from the trained models is chosen. The pre-trained decision trees already capture valuable patterns and relationships within the data. The new training phase then involves system 100 constructing new decision trees through optimization according to the decision value order adjustment operations discussed above. In some examples, the optimization involves the minimization of the loss function, which consists of a loss based on model accuracy (e.g., ability to distinguish between clean and dirty files), a loss based on decision value ordering, or a combination thereof. This approach not only leverages the strength of the existing model (AI model 120) but also allows for incremental improvements, leading to a more accurate and efficient model (second AI model 150). By building on the established ensemble, warm start training reduces the computational resources required and accelerates the convergence to an optimal solution (see FIG. 4 and corresponding test for further details).

FIG. 2A is a diagram that illustrates an example of a decision value order from an AI model, in accordance with some embodiments of the present disclosure. Decision value order 210 shows a plot of ten data samples based on their corresponding decision values. For example, decision values 130 (FIG. 1) may include prediction values of ten data samples, and FIG. 2A shows that the order of the data samples is s1, s2, s3, s4, s5, s6, s7, s8, s9, and s10 based on their prediction values. FIG. 2A also shows threshold 220 based on a false positive percentage of 10%, which classifies s10 as a false positive.

FIG. 2B is a diagram that illustrates an example of a decision value order from a first training iteration of second AI model 150, in accordance with some embodiments of the present disclosure. First iteration new decision value order 230 shows an order of data samples based on decision values from the first training iteration of second AI model 150. First iteration new decision value order 230 is different from decision value order to 210 because the order of s9 and s10 are swapped. As such, because threshold 220 remains at 10%, sample s9 is a surprise false positive 240. To preserve the decision value order, decision value order analyzer 170 determines that order offsets are required to swap the order of s9 and s10 (see FIG. 2C and corresponding text for further details).

FIG. 2C is a diagram that illustrates an example of order offsets to feed into model trainer 140 based on a first iteration decision value order, in accordance with some embodiments of the present disclosure. Decision value order analyzer 170 compares decision value order 210 with first iteration new decision value order 230, and determines that parameters corresponding to sample s10 requires an increase and parameters corresponding to sample s9 requires a decrease. As such, decision value order analyzer 170 generates order offsets 250 which includes offset 255 (increase parameters corresponding to the tenth sample) and offset 260 (decrease parameters corresponding to the ninth sample). In one embodiment, order offsets 250 are gradient offsets, Hessian offsets, or a combination thereof.

FIG. 2D is a diagram that illustrates an example of a decision value order from a second training iteration of second AI model 150, in accordance with some embodiments of the present disclosure. Second iteration new decision value order 270 is a result of inputting order offsets 250 into model trainer 140. As can be seen, the order of s9 and s10 switches, which matches decision value order 210. Therefore, the decision value ordering of AI model 120 is preserved in second AI model 150 and surprise false positives are reduced. In some embodiments, multiple training iterations are performed until second AI model 150 is at a state that preserves the decision value order.

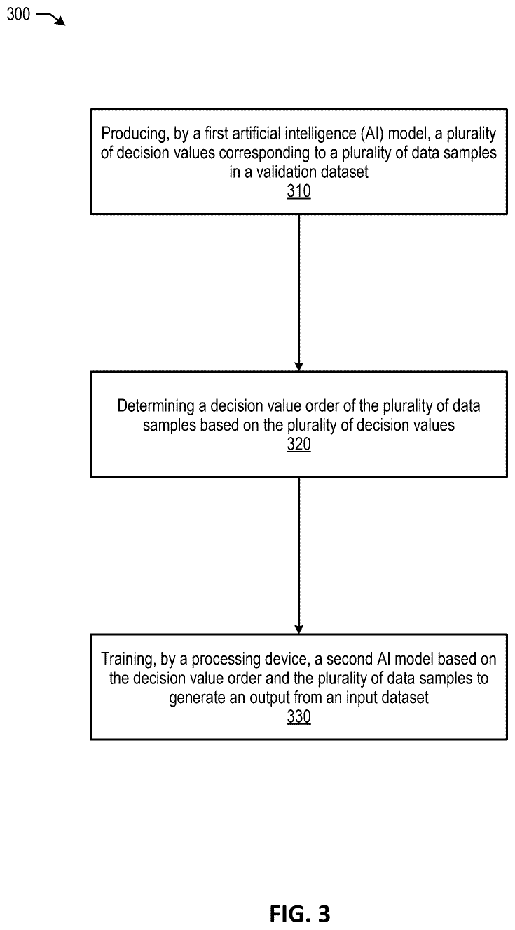

FIG. 3 is a flow diagram of a method 300 for preserving decision value order in successive AI model releases, in accordance with some embodiments of the present disclosure.

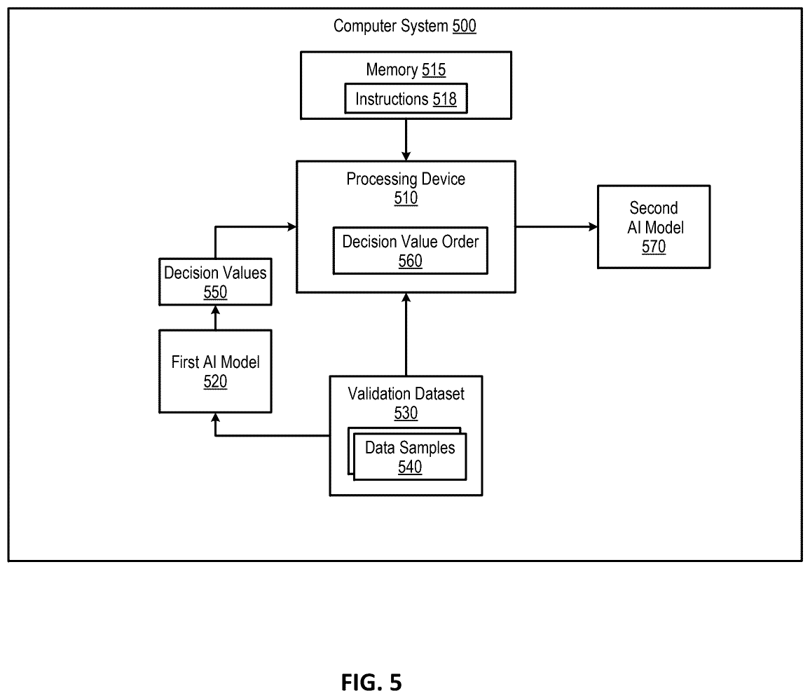

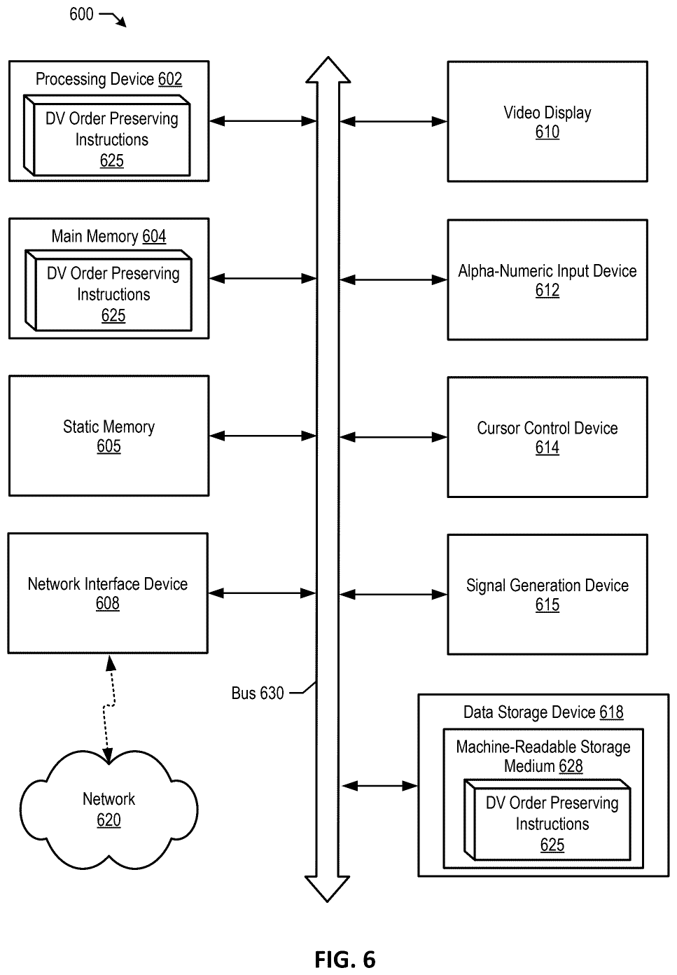

Method 300 may be performed by processing logic that may include hardware (e.g., a processing device), software (e.g., instructions running/executing on a processing device), firmware (e.g., microcode), or a combination thereof. In some embodiments, at least a portion of method 300 may be performed by model trainer 140 (shown in FIG. 1), decision value order analyzer 170 (shown in FIG. 1), processing device 510 (shown in FIG. 5), processing device 602 (shown in FIG. 6), or a combination thereof.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 400 may be performed.

With reference to FIG. 3, method 300 begins at block 310, whereupon processing logic produces, by an artificial intelligence (AI) model, a plurality of decision values corresponding to a plurality of data samples in a validation dataset. In some embodiments, the plurality of decision values include prediction values corresponding to the data samples.

At block 320, processing logic determines a decision value order of the plurality of data samples based on the plurality of decision values. The decision value order represents an order of the data samples based on their respective prediction value.

At block 330, processing logic trains a second AI model based on the decision value order and the plurality of data samples. Using the decision value order to train the second AI model preserves the order of the data samples between the first AI model and the second AI model and, in turn, reduces a number of surprise false positives from the second AI model.

FIG. 4 is another flow diagram of a method 400 for integrating a warm start approach to preserve decision value order in successive AI model releases, in accordance with some embodiments of the present disclosure. As discussed above, warm start training is a technique in machine learning where the training of a new model begins with the parameters of an already trained model, rather than starting from scratch. Warm start training can also be applied to decision tree ensembles, such as those used in gradient boosting algorithms. In this context, the training process begins by parsing and retaining some of the decision trees from the existing ensemble as discussed above. These pre-trained trees already capture valuable patterns and relationships within the data. The new training phase then involves appending additional trees to this ensemble, which are trained to correct the residual errors left by the initial set of trees. This method not only leverages the strength of the existing model but also allows for incremental improvements, leading to a more accurate and efficient model. By building on the established ensemble, warm start training reduces the computational resources required and accelerates the convergence to an optimal solution.

Method 400 may be performed by processing logic that may include hardware (e.g., a processing device), software (e.g., instructions running/executing on a processing device), firmware (e.g., microcode), or a combination thereof. In some embodiments, at least a portion of method 400 may be performed by model trainer 140 (shown in FIG. 1), decision value order analyzer 170 (shown in FIG. 1), processing device 510 (shown in FIG. 5), processing device 602 (shown in FIG. 6), or a combination thereof.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4, method 400 begins at block 410, whereupon processing logic produces, by an artificial intelligence (AI) model, a plurality of decision values corresponding to a plurality of data samples in a validation dataset.

At block 420, processing logic determines a decision value order of the plurality of data samples based on the plurality of decision values produced by the first AI model.

At block 430, processing logic evaluates a decision tree ensemble of the first AI model and removes a portion of the decision trees from the decision tree ensemble. In one embodiment, processing logic removes one or more end decision trees from the ensemble.

At block 440, processing logic trains new decision trees based on the decision value order, the plurality of data samples, and a differential training dataset corresponding to a difference between the training dataset used to train the first AI model and an updated training dataset. At block 450, processing logic appends the new decision trees to the decision tree ensemble to produce the second AI model.

FIG. 5 is a block diagram that illustrates an example system for preserving decision value order in successive AI model releases, in accordance with some embodiments of the present disclosure.

Computer system 500 includes processing device 510 and memory 515. Memory 515 stores instructions 518 that are executed by processing device 510. Instructions 518, when executed by processing device 510, cause processing device 510 to produce, by artificial intelligence (AI) model 520, decision values 550 corresponding to data samples 540 in a validation dataset 530. Processing device 510 determines a decision value order 560 of data samples 540 based on their corresponding decision values 550. In turn, processing device 510 trains a second AI model 570 based on the decision value order 560 and data samples 540.

FIG. 6 illustrates a diagrammatic representation of a machine in the example form of a computer system 600 within which a set of instructions, for causing the machine to perform any one or more of the methodologies discussed herein for preserving decision value order in successive AI model releases.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing system 600 may further include a network interface device 608 which may communicate with a network 620. The computing system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute decision value (DV) order preserving instructions 625, for performing the operations and steps discussed herein.

The data storage device 618 may include a machine-readable storage medium 628, on which is stored one or more sets of decision value order preserving instructions 625 (e.g., software) embodying any one or more of the methodologies of functions described herein. The decision value order preserving instructions 625 may also reside, completely or at least partially, within the main memory 604 or within the processing device 602 during execution thereof by the computer system 600; the main memory 604 and the processing device 602 also constituting machine-readable storage media. The decision value order preserving instructions 625 may further be transmitted or received over a network 620 via the network interface device 608.

The machine-readable storage medium 628 may also be used to store instructions to perform a method for intelligently scheduling containers, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “producing,” “determining,” “training,” “initializing,” “computing,” “updating,” “parsing,” “appending,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
producing, by a first artificial intelligence (AI) model, a plurality of decision values corresponding to a plurality of data samples in a validation dataset;
determining a decision value order of the plurality of data samples based on the plurality of decision values; and
training, by a processing device, a second AI model based on the decision value order and the plurality of data samples to generate an output from an input dataset.

2. The method of claim 1, wherein the plurality of decision values comprise a plurality of prediction values corresponding to the plurality of data samples, and wherein the decision value order represents an order of the plurality of data samples based on their respective prediction value from the plurality of prediction values.

3. The method of claim 2, wherein, using the decision value order to train the second AI model preserves the order of the plurality of data samples between the first AI model and the second AI model.

4. The method of claim 3, wherein preserving the order of the plurality of data samples reduces a number of surprise false positives of the second AI model.

5. The method of claim 1, wherein the training further comprises:
initializing the second AI model with a set of parameters;
computing, using the second AI model, a plurality of prediction values for the plurality of data samples;
determining a new decision value order of the validation dataset based on the plurality of prediction values;
determining a set of gradient offsets based on a difference between the decision value order and the new decision value order; and
updating the set of parameters of the second AI model based on the set of gradient offsets.

6. The method of claim 1, wherein the first AI model comprises a decision tree ensemble of a plurality of decision trees, the method further comprising:
parsing at least one decision tree from the plurality of decision trees to produce a parsed decision tree ensemble;
training a new decision tree based on the decision value order; and
appending the new decision tree to the parsed decision tree ensemble to produce the second AI model.

7. The method of claim 6, wherein the training the new decision tree is based on a differential training dataset corresponding to a difference between a training dataset used to train the first AI model and an updated training dataset.

8. The method of claim 1, wherein the second AI model is an updated release of the first AI model.

9. A system comprising:
a memory; and
a processing device, that is operatively coupled to the memory, to:
produce, by a first artificial intelligence (AI) model, a plurality of decision values corresponding to a plurality of data samples in a validation dataset;
determine a decision value order of the plurality of data samples based on the plurality of decision values; and
train a second AI model based on the decision value order and the plurality of data samples to generate an output from an input dataset.

10. The system of claim 9, wherein the plurality of decision values comprise a plurality of prediction values corresponding to the plurality of data samples, and wherein the decision value order represents an order of the plurality of data samples based on their respective prediction value from the plurality of prediction values.

11. The system of claim 10, wherein using the decision value order to train the second AI model preserves the order of the plurality of data samples between the first AI model and the second AI model.

12. The system of claim 11, wherein preserving the order of the plurality of data samples reduces a number of surprise false positives between the first AI model and the second AI model.

13. The system of claim 9, wherein the processing device is further to:
initialize the second AI model with a set of parameters;
compute, using the second AI model, a plurality of prediction values for the plurality of data samples;
determine a new decision value order of the validation dataset based on the plurality of prediction values;
determine a set of gradient offsets based on a difference between the decision value order and the new decision value order; and
update the set of parameters of the second AI model based on the set of gradient offsets.

14. The system of claim 9, wherein the first AI model comprises a decision tree ensemble of a plurality of decision trees, and wherein the processing device is further to:
parse at least one decision tree from the plurality of decision trees to produce a parsed decision tree ensemble;
train a new decision tree based on the decision value order; and
append the new decision tree to the parsed decision tree ensemble to produce the second AI model.

15. The system of claim 14, wherein the training the new decision tree is based on a differential training dataset corresponding to a difference between a training dataset used to train the first AI model and an updated training dataset.

16. A non-transitory computer readable medium, storing instructions that, when executed by a processing device, cause the processing device to:
produce, by a first artificial intelligence (AI) model, a plurality of decision values corresponding to a plurality of data samples in a validation dataset;
determine a decision value order of the plurality of data samples based on the plurality of decision values; and
train, by the processing device, a second AI model based on the decision value order and the plurality of data samples to generate an output from an input dataset.

17. The non-transitory computer readable medium of claim 16, wherein the plurality of decision values comprise a plurality of prediction values corresponding to the plurality of data samples, and wherein the decision value order represents an order of the plurality of data samples based on their respective prediction value from the plurality of prediction values.

18. The non-transitory computer readable medium of claim 17, wherein using the decision value order to train the second AI model preserves the order of the plurality of data samples between the first AI model and the second AI model, and wherein preserving the order of the plurality of data samples reduces a number of surprise false positives between the first AI model and the second AI model.

19. The non-transitory computer readable medium of claim 16, wherein the processing device is further to:
initialize the second AI model with a set of parameters;
compute, using the second AI model, a plurality of prediction values for the plurality of data samples;
determine a new decision value order of the validation dataset based on the plurality of prediction values;
determine a set of gradient offsets based on a difference between the decision value order and the new decision value order; and
update the set of parameters of the second AI model based on the set of gradient offsets.

20. The non-transitory computer readable medium of claim 16, wherein the first AI model comprises a decision tree ensemble of a plurality of decision trees, and wherein the processing device is further to:
parse at least one decision tree from the plurality of decision trees to produce a parsed decision tree ensemble;
train a new decision tree based on the decision value order and a differential training dataset corresponding to a difference between a training dataset used to train the first AI model and an updated training dataset; and
append the new decision tree to the parsed decision tree ensemble to produce the second AI model.
